(19) United States
(12) Patent Application Publication
(10) Pub. No.: US 2009/0138574 A1
(43) Pub. Date: May 28, 2009

(54) Information processing and transportation architecture for data storage

(75) Inventors: Joseph Y. Hui, Fountain Hills, AZ (US); Prabhanjan Gurumohan, Tempe, AZ (US); Sai B. Narasimhamurthy, Fremont, CA (US); Sudeep S. Jain, Fremont, CA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Arizona Board of Regents

(21) Appl. No.: 10/592,766

(22) PCT Filed: Apr. 12, 2005
(86) PCT No.: PCT/US05/12446

§ 371 Date: Jan. 30, 2009

Related U.S. Application Data
(60) Provisional application No. 60/561,709, filed on Apr. 12, 2004.

(51) Int. Cl. G06F 15/16

(52) U.S. Cl. 709/219

(57) ABSTRACT

A new architecture for networked data storage is proposed for providing efficient information processing, and transportation. Data is processed, encrypted, error checked, redundantly encoded, and stored in fixed size blocks called quanta. Each quantum is processed by an Effective Cross Layer protocol that collapses the protocol stack for security, iWARP and iSCSI functions, transport control, and even RAID storage. This streamlining produces a highly efficient protocol with fewer memory copies and places most of the computational burden and security safeguard on the client, while the target stores quanta from many clients with minimal processing.

### CROSS REFERENCE TO RELATED APPLICATIONS

This application claims priority from U.S. provisional patent application Ser. No. 60/560,225 entitled “Quanta Data Storage: An Information Processing and Transportation Architecture for Storage Area Networks” filed on Apr. 12, 2004, which is incorporated herein by reference.

### BACKGROUND

The invention pertains to digital data processing and, more particularly, to networked storage networks and methods of operation thereof.

In early computer systems, long-term data storage was typically provided by dedicated storage devices, such as tape and disk drives, connected to a data central computer. Requests to read and write data generated by applications programs were processed by special-purpose input/output routines resident in the computer operating system. With the advent of “time sharing” and other early multiprocessing techniques, multiple users could simultaneously store and access data—albeit only through the central storage devices.

With the rise of the personal computer (and workstation) in the 1980's, demand by business users led to development of interconnection mechanisms that permitted otherwise independent computers to access data on one another's storage devices. Though computer networks had been known prior to this, they typically permitted only communications, not storage sharing.

The prevalent business network that has emerged is the local area network, typically comprising “client” computers (e.g., individual PCs or workstations) connected by a network to a “server” computer. Unlike the early computing systems in which all processing and storage occurred on a central computer, client computers usually have adequate processor and storage capacity to execute many user applications. However, they often rely on the server computer—and its associated battery of disk drives and storage devices—for other than short-term file storage and for access to shared application and data files.

An information explosion, partially wrought by the rise of the corporate computing and, partially, by the Internet, is spurring further change. Less common are individual servers that reside as independent hubs of storage activity. Often many storage devices are placed on a network or switching fabric that can be accessed by several servers (such as file servers and web servers) which, in turn, service respective groups of clients. Sometimes even individual PCs or workstations are enabled for direct access of the storage devices (though, in most corporate environments such is the province of server-class computers) on these so-called “storage area networks.”

Communication through the Internet is based on the Internet Protocol (IP). The Internet is a packet-switched network versus the more traditional circuit switched voice network. The routing decision regarding an IP packet's next hop is made on a hop-by-hop basis. The full path followed by a packet is usually unknown to the transmitter 3 but it can be determined after the fact.

Transmission Control Protocol (TCP) is a transport layer 4 protocol and IP is a network layer 3 protocol. IP is unreliable in the sense that it does not guarantee that a sent packet will reach its destination. TCP is provided on top of IP to guarantee packet delivery by tagging each packet. Lost or out of order packets are detected and then the source supplies a responsive retransmission of the packet to destination

Internet Small Computer System Interface (iSCSI) was developed to provide access to storage data over the Internet. In order to provide compatibility with the existing storage and the Internet structure, several new protocols were developed. The addition of these protocols has resulted in highly inefficient information processing, bandwidth usage and storage format.

Specifically, iSCSI protocol provides TCP/IP encapsulation of SCSI commands and transport over the Internet in lieu of a SCSI cable. This facilitates wide-area access of data storage devices.

This network storage may require very high speed network adapters to achieve networked storage with desired throughputs of, for example, 1 to 10 Gb/s. Storage protocols such as iSCSI and TCP/IP must operate at similar speed, which can be difficult. Calculating checksums for both TCP over iSCSI consumes most of the computing cycles, slowing the system, for example, to about 100 Mb/s in the absence of TCP Off-Load Engines (TOEs). The main bottleneck often is system copying consuming much of the I/O bandwidth. If vital functions of security such as those of Internet Protocol Security (IPSec) were to be added beneath the TCP layer, the storage client and target without offloading may slow to tens of Mb/s.

The problem arises from a piecemeal construction of network storage protocols by adding layers to facilitate functions. To reduce the number of memory copies, a remote direct memory access (RDMA) consortium was formed to define a new series of protocols called iWARP (between the iSCSI and TCP layers. To facilitate data security, an IPSec layer may be added at the bottom of the stack. To improve storage reliability, software RAID may be added to the top of the stack.

There are a number of problems with this stacked model. First, each of these protocols can be computational intensive, e.g. IPSec. Second, excessive layering creates a large protocol header overhead. Third, the IPSec model entails encryption and decryption at the two ends of a transmission pipe, thereby producing security problems for decrypted data in storage. Fourth, functions such as error control, flow control, and labeling are repeated across layers. This repetition often consumes computing and transmission resources unnecessarily, e.g. the TCP 2-byte checksum may not be necessary given a more powerful 4-byte checksum of iSCSI. Worse, repeated functions may produce unpredictable interactions across layers, e.g. iSCSI flow control is known to interact adversely with TCP flow control.

While the RDMA and iSCSI Consortia have made steady progress, this protocol stack has grown overly burdensome, while paying insufficient attention to vital issues of network security and storage reliability. TOE and other hardware offload may solve some, but not all of the problems mentioned above. Furthermore, developing offload hardware is expensive and difficult with evolving standards. Adding hardware increases cost of the system.

Thus, what is needed is an improved system and method of processing and transmitting data over a storage network.

### SUMMARY

To achieve the foregoing and other objects, and in accordance with the purposes of the present invention, as embodied and broadly described herein, an improved data transmission, processing, and storage system and method uses a quantum data concept. Since data storage and retrieval processes such as SCSI and Redundant Array of Inexpensive Disks (RAID) are predominantly block-oriented, embodiments of the present invention replace a whole stack with a flattened protocol based on a same size data block called a quantum, instead of using byte-oriented protocols TCP and IPSec. The flattened layer, called the Effective Cross Layer (ECL), allows for in-situ processing of many functions such as CRC, AES encryption, RAID, Automatic Repeat Request (ARQ) error control, packet resequencing and flow control without the need for expensive data copying across layers. This obtains a significant reduction of addressing and referencing by synchronous delineation of a Protocol Data Unit (PDU) across the former layers.

Embodiments of the present invention combine error and flow control across the iSCSI and TCP layers using the quantum concept. A rate-based flow control is also used instead of the slow start and congestion avoidance for TCP.

In accordance with another aspect of the present invention, the SNACK (Selective Negative Acknowledgement) approach of iSCSI is modified for error control, instead of using ARQ of TCP.

In another aspect, we add the option of integrating RAID as one of the protocol functions. The RAID function is most likely performed at the target in-situ with quantum processing.

In yet a further aspect, an initiator may compute a yin yang RAID code, doubling transmission volume while allowing use of similar redundancy to handle both network and disk failures.

In another aspect, a protocol is designed asymmetrical, i.e. placing most of the computing burden on a client instead of a storage target. The target stores encrypted quanta after checking a Cyclic Redundant Check (CRC) upon reception. One version allows the storage of verified CRC also, so that re-computation of CRC during retrieval is made unnecessary. Storing CRC also facilitate the detection of data corruption during storage. This asymmetry takes advantage of the fact that data speed requirement at the client probably is sufficient at around 100 Mb/s. This speed is achievable for, for example, multi-GHz client processors protocol without hardware offload. By exploiting the processing capability of the many more clients served by a storage target, improved data storage at the target is achieved without hardware offload.

### BRIEF DESCRIPTION OF THE FIGURES

A general architecture as well as services that implement the various features of the invention will now be described with reference to the drawings of various embodiments. The drawings and the associated descriptions are provided to illustrate embodiments of the invention and not to limit the scope of the invention.

FIG. 1 is a diagrammatic illustration of a protocol stack for a storage network and flow process;

FIG. 2 is a diagrammatic illustration of a general architecture of a QDS system in accordance with the present invention;

FIG. 3a is a diagrammatic illustration of an iSCSI stack on iWARP with IPSec;

FIG. 3a is a diagrammatic illustration of an ECL model for secure and reliable iSCSI accordance with the present invention;

FIG. 4 is a diagrammatic illustration of an ECL header for WRITE in accordance with the present invention;

FIG. 5 is a flow diagram of a pipeline processing of quanta in accordance with an embodiment of the present invention;

FIG. 6 illustrates encoding of quanta (7a) and decoding of quanta (7b, c, and d) in accordance with an embodiment of the present invention;

FIG. 7 illustrates a yin yang code process in accordance with an embodiment of the present invention; and

FIG. 8 illustrates multiple layer protocol encapsulation in accordance with an embodiment of the present invention

### DETAILED DESCRIPTION

### I. Overview

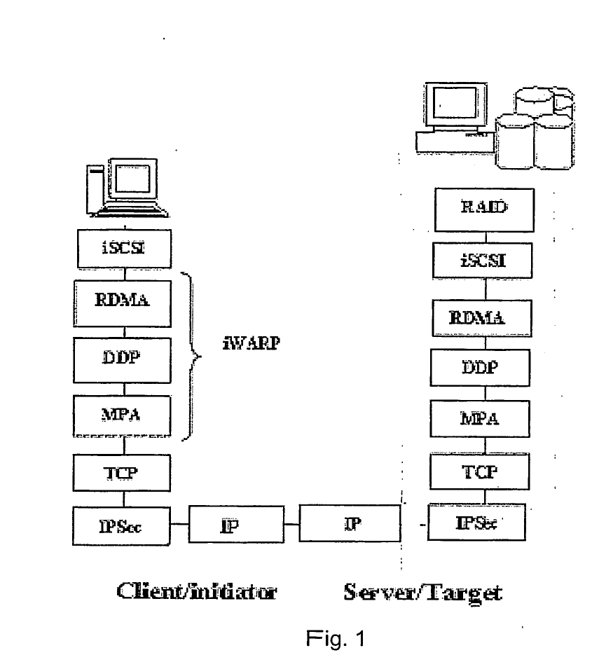

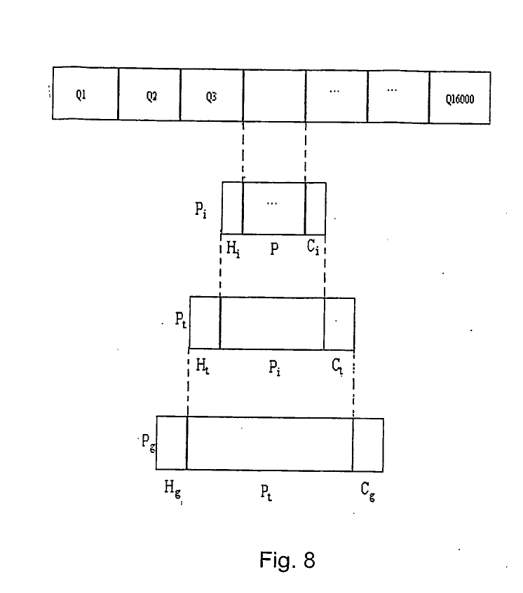

In general, embodiments of the present invention relate to an Effective Cross Layer (ECL) that provides an efficient information storage, processing and communication for networked storage. One embodiment of the ECL is a combination of several other protocols currently in use for communication of data over the Internet as shown in FIG. 1. Information processed by the ECL is formatted into a fixed data unit size called a quantum, as shown in FIG. 8. The combination of ECL and the quantum data processing leads to a reduction in the data processing time and an improvement in bandwidth usage.

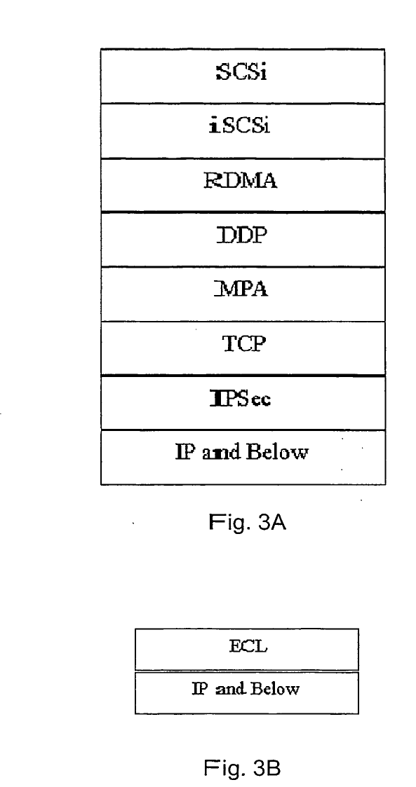

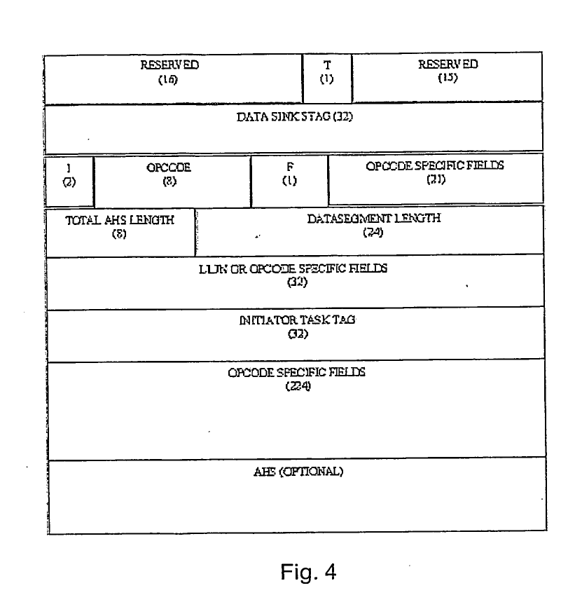

An embodiment of an ECL and quantum data is shown in FIG. 3B. As compared with a conventional layer, shown in FIGS. 1 and 3A, the ECL layer combines the features of the SCSI, iSCSI, RDMA, DDP, MP A, TCP and IPSec as the ECL. FIG. 4 illustrates a practical embodiment of an ECL header.

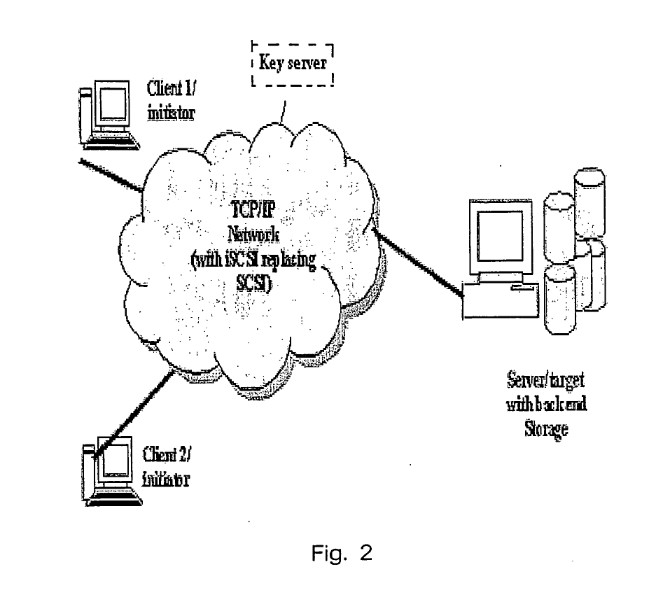

With further reference to FIG. 2, keys are stored on a separate key server, which are used for encryption of these quanta. These keys can be accessed by the clients that are permitted to access the data in the SAN. Any client that needs to access the data can obtain the preformatted packets from the storage devices. The clients can access the corresponding keys from the key server and decrypt the packet.

Select components and variations of the above described general overview are described in greater detail below.

### II. The Quanta Data Storage

By way of background, conventional layered protocols allow variable size of Protocol Data Unit (PDU) for each layer. The PDU of a higher layer is passed onto a lower layer. The lower layer may fragment the upper layer PDU. Each fragment is added to its own protocol header. A CRC (Cyclic Redundancy Check) is added as a trailer for the purpose of error checking. The header, the fragmented PDU, and the trailer together form a PDU at the lower layer. The enveloping of the fragmented PDU by the header and the trailer is termed encapsulation. This process of fragmentation and encapsulation is repeated as the new lower layer PDU is passed onto yet lower layers of the protocol stack.

In iSCSI, a burst (e.g., <16 Megabytes (MB)) is fragmented into iSCSI PDUs, which are further fragmented into TCP PDUs, then the IP PDUs, and finally the Gigabit Ethernet (GBE) PDUs.

In accordance with the present invention, a fixed number of bytes of data are chosen (not including the protocol headers and trailers added at each layer,, and the QDS system does not fragment smaller than a quantum. Thus, each PDU for the layers has the same delimitation. This is referred to as cross layer PDU synchronization.

One advantage of QDS is allowing a common reference of PDUs across the layers. For example with a quantum size of 1024B, a burst is fragmented into a maximum of 16 thousand quanta. Hence each quantum can be referenced sequentially from 1 to 16 thousand using a 14 bit or two byte quantum address within a burst.

As a result of PDU synchronization and quantum addressing, QDS may achieve zero-copying of data since the burst identity together with the quantum address uniquely defines the memory location where the quantum should be copied. This allows in-situ processing of a quantum by various layers without “expensive” data copying of data across layers, as done in the traditional protocol stack.

A. Quantum Data Processing

Data transport such as SCSI, encryption such as Advanced Encryption Standard (AES), and reliability encoding such as RAID are block oriented. In accordance with the present invention, preferred embodiments advantageously unify the block size of the data units of these functions. Furthermore, these functions may be performed centrally without data copying across protocol layers.

In a conventional stack, shown in FIG. 3a, a byte-oriented transport protocol TCP is inserted between the block oriented iSCSI layer and the IPSec layer. This mismatch of TCP byte addressing versus SCSI block addressing creates complications if arriving TCP/IP packets are to be copied directly into the kernel space without multiple copying, because packets could be lost, fragmented, or arrive out-of-sequence. In order to properly reference data, the iWARP protocol requires an intermediate framing protocol called the MPA to delimit boundaries of TCP PDUs through pointers.

As best seen in FIG. 8, a fixed PDU length is used across various layers. Moreover, the PDU of the various layers are aligned, thereby simplifying the referencing of data. Furthermore, similar functions such as CRC, flow control, sequencing, and buffer management may be unified across layers. For example, a 2-byte checksumming of TCP may be omitted and instead rely on more powerful 4-byte checksumming of iSCSI. An ARQ of TCP may not be necessary if the SNACK (Selective Negative Acknowledgment) of iSCSI is properly made to replace the TCP function of ensuring reliable transmission. Also, TCP buffering and re-sequencing may be omitted when iSCSI and its SNACK mechanism places properly data blocks using its quantum address within a burst.

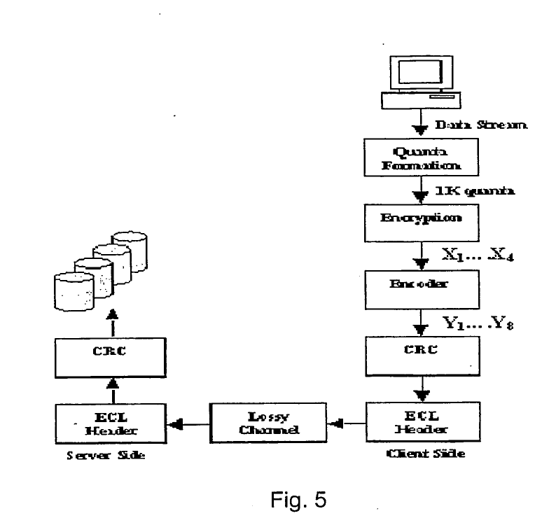

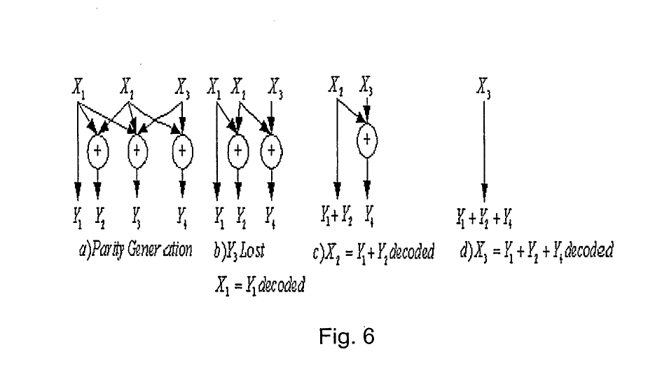

An exemplary pipeline of quantum data processing is indicated in FIG. 5. A unified block size allows in-situ pipelined processing of a quantum of data for the many functions, including redundancy encoding, encryption and CRC checksumming, which are computationally intensive. Data is first formed into quantum size blocks and encrypted. The fixed size data units are encrypted by keys from a key server to form Encrypted Data Units (EDUs) of the same fixed size.

Subsequently, RAID encoding may be performed at a client. Alternatively, RAID encoding may be performed at the target. A more detailed description of an embodiment of the RAID process is described further below.

An encrypted and encoded quantum is used to generate a 4-byte CRC check. Subsequently, an ECL header is added before transmission.

In an embodiment, EDUs are not allowed to be fragmented by the Internet. To ensure non-fragmentation, the size of the minimum path MTU between the server and the client is checked. The EDU size then set, for example, at 1 KB (1024 bytes). Each quantum is addressed within a burst.

The EDUs sent to the server are stored in the server “as is” (e.g., without decryption). The ECL headers are stripped away and the EDUs are stored in the server. Thus, minimal processing is required at the target.

Clients retrieving data require obtaining a key that is data specific. This security arrangement effectively treats raw data storage in disks as unreliable and insecure. Hence encryption and channel/RAID coding is performed “end-to-end”, i.e. from the instant of writing into disks to the instant of reading from disks. We believe the inclusion of this end-to-end security paradigm directly into a storage protocol promotes network storage security.

B. Effective Cross Layer

An embodiment of an Effective Cross Layer in accordance with the present invention is shown in FIG. 3b. The Effective Cross Layer (ECL) uses a header that incorporates the functionalities of iSCSI, Remote Direct Memory Access (RDMA), Direct Data Placement (DDP), Marker PDU aligned Framing for TCP (MPA) and Transport Control Protocol (TCP) mechanism. Some of the functionalities in the Effective Cross Layer are set forth below:

1) iSCSI functions: The Effective Cross Layer retains most of iSCSI functions. Information for read, write, and the EDU length is retained.

2) Copy avoidance: The copy avoidance function in the iWARP suite is accomplished by the DDP and the RDMA protocols. The DDP protocol specifies buffer addresses for the transport payloads to be directly placed in the application buffers without kernel copies (TCP/IP related copies). RDMA communicates READ and WRITE semantics to the application. RDMA semantics for WRITE and READ are defined in the iSCSI header. The ECL header also provides buffer address information.

The MPA protocol, which deals with packet boundaries and packet fragmentation problems, may be omitted. Each quantum is directly placed in the application buffer according to its quantum address. These buffer addresses are present in the ECL header in the form of Steering Tags (STAGs).

3) Transport functions of the ECL: The ECL header also serves as a transport header.

4) Security considerations: Only clients that have access to keys from the key server can decrypt data retrieved. Security is considered a high layer function, instead of using IPSec beneath the TCP layer.

### III. Cross Layer Quantum Based Error Checking

A preferred method of Quantum Data Storage (QDS) paradigm used for joint processing for checking errors that occur across layers of a storage protocol is illustrated in FIG. 8, as briefly described earlier. Often the CRC trailer can be incorporated into the associated header. Use of a fixed size data unit across multiple layers, which is stored by mechanisms of zero-copying at one memory location, allows in-situ error checking for multiple layers of the storage protocol. This in-situ cross layer processing, combined with the following innovation in cross-layer error checking, results in significant reduction in computation requirements for error checking, which often consumes the largest fraction of computing cycles of the processing for storage protocols.

Functions such as error checking are repeated across layers as each layer deals with distinctive errors arising with the hardware associated with each layer. For example, the access layer by GBE (called layer 2 in the OSI architecture) detects errors arising in the Ethernet interface and the physical transmission, using a 4B CRC. The TCP layer (layer 4 for OSI) detects errors arising in the routers in the end-to-end path of transmission as well as end-system operating systems, using a 2B CRC. The iSCSI layer (application layer) detects errors arising in the end-system application space as well as protocol gateways, using; a 4B CRC.

We represent the binary sequence of PDU at the iSCSI layer, the TCP layer, and the GBE layer as Pᵢ, Pₗ, and P_{g} respectively. We call the headers at these layers respectively as Hᵢ, Hₗ, and H_{g}. We call CRC trailers as Cᵢ, Cₗ, and C_{g} respectively. It should be noted that between TCP (layer 4) and GBE (layer 2), we have the DP layer (layer 3) which does not perform error checking on the data payload and relegates the function of error checking to TCP. In the following discussion, we subsume the IP header into the TCP header for the purpose of CRC generation.

In practice for GBE, CRC generation at the transmit end and CRC checking at the receive end are performed by the GBE hardware (called NIC, or Network Interface Card) without using precious CPU cycles of the host computer. Recent NIC implementations allow the host computer to offload CRC computation and checking for TCP onto the NIC. Given the stronger error checking capability of iSCSI (4B versus the 2B of TCP), it can be argued that TCP CRC function is not necessary, since iSCSI CRC would cover also errors arising in the lower layer of TCP.

Hence we simplify the discussion by simply looking at the generation of CRC at the iSCSI and the GBE layers, and subsume all intermediate layer headers into the iSCSI header Hᵢ. Henceforth, a block of bits is represented as numbers with the left most bit as most significant, e.g., the block of bits 11001 is numerically represented as 2⁴+2³+2⁰=16+8+1=25. CRC checksums are generated by finding remainder after division, e.g., 25 mod 7=4, giving the CRC checks 100.

The computation of the CRC is described here between the iSCSI and GBE layers, assuming no CRC done at the TCP layer by the host CPU. To compute the CRC for GBE the remainder is found resulting from dividing the binary number represented by the concatenation of the GBE header H_{g} and the GBE data payload (which is the data passed on from the iSCSI layer Pᵢ. A divisor D_{g} is used for which GBE is a 2B binary number. In other words, the CRC checks are given by:

C_{g}=(H_{g}2ⁿ+Pᵢ)mod D_{g}.

In the above equation, n is the length of the data Pᵢ. The remainder of the header plus data is found by modulo arithmetic through division by D_{g}, generating a 4B remainder C_{g} which is then appended to H_{g} and Pᵢ to form the GBE PDU represented by the H_{g}PᵢC_{g} concatenation. In numerical representation, we have

P_{g}=H_{g}2ⁿ⁺³²+Pᵢ2³²+C_{g}.

At the receiving GBE NIC, hardware internal to the NIC computes the remainder P_{g} mod D_{g} If no error occurs in the GBE PDU, we have P_{g} mod D_{g}=0. If P_{g} mod D_{g}≠0, an error is detected and the GBE PDU is discarded. Consequently, the receiving GBE NIC requests retransmission of the discarded GBE PDU from the transmitting GBE.

This error checking scheme detects error occurring between two NICs. However as pointed out earlier, it does not detect error occurring inside routers, when Pᵢ may be corrupted. Since the GBE NIC computes the CRC based on the corrupted Pᵢ, the error would not be detected. Let the original uncorrupted iSCSI PDU be P_{i,original}≠Pᵢ. The bit sequence of P_{i,original} is the concatenation of HᵢPCᵢ where P is the 1024B quantum formed by breaking up the iSCSI burst. In numerical representation, we have

P_{i,original}=Hᵢ2^{m+32}+P2³²+Cᵢ.

In this equation, we may have m=1024×8, which is the size of a quantum in bits. The CRC check is:

Cᵢ=(Hᵢ2^{m}+P)mod Dᵢ.

In the process of end-to-end routing, we may have corruption resulting in Pᵢ≠P_{i,original}. For iSCSI, the CRC error checking will result in Pᵢ mod Dᵢ≠0.

The computation of Pᵢ mod Dᵢ≠0 at the iSCSI layer can be done in conjunction with the computation of P_{g} mod D_{g} at the GBE layer. We assume the CRC are generated using the same divisor D=Dᵢ=D_{g}.

Suppose no error is detected at the GBE layer, i.e. P_{g} mod D=0. Now we have P_{g}=H_{g}2ⁿ⁺³²+Pᵢ2³²+C_{g}. Hence if Pᵢ mod D≠0, we must have (H_{g}2ⁿ⁺³²+C_{g}) mod D≠0 in order to have P_{g} mod D=0. (It should be noted that the second term on the right hand side of P_{g}=H_{g}2ⁿ⁺³²+Pᵢ2³²+C_{g} has Pᵢ2³² mod D≠0 if and only if Pᵢ mod D≠0.

In other words, an error at the iSCSI layer is detected if (H_{g}2ⁿ⁺³²+C_{g})mod D≠0. This is substantially simpler to compute than the equivalent condition of Pᵢ mod D_{i≠}0 because the header H_{g} and the trailer C_{g} are substantially shorter than Pᵢ. In fact:

(H_{g}2ⁿ⁺³²+C_{g})mod D=[(H_{g} mod D)×(2ⁿ⁺³² mod D))+C_{g}]mod D.

The right hand side of the above equation simplifies the division of a very long division (>1024B) into a few much shorter (in few tens of bytes) divisions and multiplications. This computation can be easily handled by the host CPU.

Therefore, the above joint CRC error checking for iSCSI is substantially simpler than the usual means of CRC checking for iSCSI alone.

### IV. Quantum Based Transport Mechanism

An embodiment in accordance with the present invention utilizes an improved transport protocol for QDS, which desirably achieves the reliability of TCP and the high throughput of UDP. This embodiment uses an improved rate-based flow control which is more suitable for high throughput applications over long distances. Moreover, the embodiment uses an approach of selective repeat for retransmission of corrupted or lost packets.

1. Existing TCP and iSCSI Approaches

Window flow control of TCP allows for a window's worth of data to be transmitted without being acknowledged. Window size is adaptive to network congestion conditions. With high throughput requirement and long propagation delay, the amount of data in transit can be large. To adapt the window size, most TCP implementations use slow start and congestion avoidance. The sender gradually increases window size. When congestion is detected, window size is reduced often by half. Window size is reduced geometrically if congestion persists.

In the iSCSI standard, a maximum burst size is defined (<16 MB) for the purpose of end-to-end buffer flow control. A large file transfer is broken into multiple bursts handled consecutively. A burst buffer is allocated. Burst size is typically much larger than TCP window size. In taxing iSCSI applications requiring say 1 Gb/s throughput in a network suffering a propagation delay of 30 milliseconds, there may be a bandwidth delay product as large as 30 Megabits or 4 Megabytes, which is the amount of data in transit

Such large volume of data in transit may render the ARQ and flow control used in TCP inadequate. Furthermore, retransmission and flow control mechanisms defined in iSCSI may interact adversely with TCP flow and error control.

2. OPS Error Control

As an example, assume a maximum burst or window size of 4 MB and a quantum size of 1KB, each quantum in a burst can be addressed by 12 bits as there are less than 4096 quanta in a burst. This is the quantum address. If the iSCSI standard of 16 MB maximum burst size is adopted, then 14 bit quantum addresses may be used.

In accordance with the QDS error control of present invention, a receive end may request retransmissions of runs of quanta, given by -he starting quantum address, e.g. encoded by 12 bits, for retransmission and 4 bits can be used to encode the run length of the number of quanta to be retransmitted. Multiple runs may be retransmitted within a burst. If an excessive number of runs are to be retransmitted, a burst itself may be retransmitted in its entirety or a connection failure may be declared.

Unlike TCP ARQ, which often retransmits the entire subsequent byte stream from a packet detected to be lost, QDS employs selective repeats and therefore substantially more state information should be retained by the receive end concerning quanta that have to be retransmitted. In an example of 4 MB maximum burst size and 1024B quanta, a maximum of 4096 quanta in a burst may be used. Thus, up to 512B for recording the status of correct reception of quanta in a burst may be used. We call this record the reception status vector. A correctly received quantum changes the bit at a bit location equal to its quantum address.

A counter is used to record the number of correctly received quanta in a burst. A timer may be used, also, to time-out the duration of a burst transmission and another timer may record the time lapsed since the last reception of a quantum. When the last few quanta are received, or when the burst time-out is observed, or when excessive time has elapsed since last receiving a quantum, the status of the burst reception would be reviewed for further action.

The review consists of extracting 4 bytes of the reception status vector at a time. If the 4 bytes consist entirely of 1'S, we have all 32 quanta received correctly. Otherwise, the locations of the first and last 0 are extracted. The run length between these locations is computed and coded for retransmission.

Current iSCSI standard allows for the retransmission of a single run based on a byte addressed SNACK, which communicates via a 4-byte address the starting byte of retransmission and another 4-byte field representing the run length in bytes of data to be retransmitted. The use of quantum addresses requires only 2 bytes for both the starting address and run length. This economy of address representation allows more selective retransmission of multiple runs. Errors are more precisely located than a single run allowed for the current iSCSI standard.

Retransmission is requested per burst using a PFTA (Post File Transfer Acknowledgment) mechanism. If there is an excessive amount of lost quanta, a retransmission of the entire burst may be requested, or a connection failure declared. Also, retransmission itself may be received with errors and on occasions multiple retransmissions may become necessary. Also, timers may become necessary to safeguard against the possibility of lost SNACKs.

In an embodiment, quantum sequencing is automatically performed in the application buffer. Out-of-sequence reception of packets is easily handled. Given the explicit quantum addressing, quanta need not be transmitted in sequence. There is an advantage to interleave the transmission of quanta if RAID type redundancy is used.

3. OPS Flow Control

Burst sizes are typically large compared to the normal TCP window size, thus, an additional flow control mechanism is needed to handle network congestion. A version of flow control regulates the transmission rate of the source to adapt to the slowest and most congested link within the end-to-end path. If a fast stream of packets are sent, slow links would slow down the stream in transit. The interarrival times of packets at the receive end is a good indicator of the bandwidth available in the slowest link. The transmitter should transmit consecutively at intervals T larger than the average interarrival times measured at the receiver. Variance of interarrival times can also indicate the quality of the path, with small variance being desirable. A large variance may increase T appropriately.

In accordance with QDS of the present invention, at the beginning of each burst, a small number of quanta of a burst are sent into the network back to back for the purpose of determining T. The value of T may be adjusted according to the condition of the interarrival times at the receive end. The receive end monitors the interarrival times and communicate a traffic digest periodically back to the transmit end for the purpose of determining the flow control parameter T.

### V. Quantum Processing of Raid Functions

RAID promotes data reliability. Protection against disk failures is done through redundantly encoding and the striping of data for storage in an array of disks. Besides reliability achieved by redundantly encoded data stored in an array of disks, RAID allows for higher speed parallel data storage and retrieval though data striping.

Embodiments of the present invention treat network storage as a combination of unreliable and insecure space-time retrieval of data that incorporate the RAID scheme as a protection against both transmission and storage errors. A quantum, upon reception or retrieval, can also be considered erased if CRC checksums indicate an error.

Embodiments of the present invention redundantly encode quanta, either at the client or at the target and distribute these redundant quanta to different locations for diversified storage.

1. A New Paradigm for Distributed Network RAID

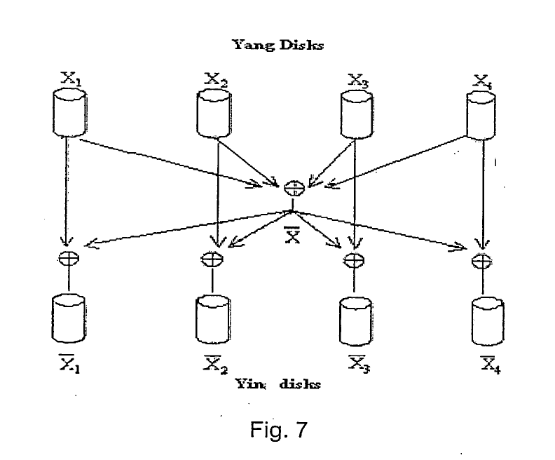

A technique of networked RAID in accordance with the present invention is illustrated in FIG. 7, which illustrates how parities are formed and how disk failures are corrected. In a first step, a basket of n encrypted quanta x=(x₁, x₂, . . . , xₙ) is provided, which is encoded into the coded basket y=(y₁, y₂, . . . , yₘ). The encoded quantum yⱼ is formed by the bit-wise exclusive-or of a number of quanta xᵢ's as shown in the parity graph of FIG. 7a. To reduce computation, the parity exemplary graph is sparse.

Decoding in the presence of erasures of packet is shown in FIGS. 7b, c, and d. As an example, assume that the quantum y₃ is lost, either in transmission or in storage. In FIG. 7b, we see readily that x₁=y₁, thus eliminating an unknown x₁. This process of elimination may be repeated to decode xᵢ that is singly connected to yⱼ.

In a preferred embodiment, a yin yang code is used for QDS.

2. Yin Yang Code

Embodiments of the present invention use a novel and improved code, referred to as a yin yang code, for handling, among other things, erasures. As the name suggests, a yin yang part comprises original data (the yang copy) and its negative image (the yin copy). As shown in FIG. 7, the yang data is systematic data in four disks, e.g. x₁, x₂, x₃, x₄. In a next step, a parity of the data is computed: x̅=x₁+x₂+x₃+x₄.

The yin part of the code is x̅₁, x̅₂, x̅₃, x̅₄ with

x̅₁= x̅+x₁, x̅₂= x̅+x₂, x̅₃= x̅+x₃, x̅₄= x̅+x₄

The data transmitted are x₁, x₂, x₃, x₄ and x̅₁, x̅₂, x̅₃, x̅₄, which form an (8, 4) code.

Advantageously, the yin yang code can correct all single, double, and triple disk failures. It can also correct all but 14 out of the 70 combinations of quadruple disk failures. Its performance is superior to level-3+1 RAID in terms of error correction capability and fewer disks required. Level-3+1 RAID uses four data disks and a fifth parity disk and a mirroring of these five disks. Yin yang code provides more than 7 fold reduction in the probability of failure to decode. This better performance is achieved with, a remarkable 20% saving in storage requirement since the level-3+1 RAID requires the use of 10 disks instead of 8 for yin yang code.

3. RAID Protocols

Having described the yin yang code, we discuss the protocol aspects of RAID for QDS.

Preferably, the yin yang encoding is applied at the client. This has the advantage of allowing up to four losses out of eight transmitted quanta. In alternative embodiments, the yin yang encoding is applied at the target. Transmission error is detected by checking the CRC of a quantum. If an error is detected and considered correctible, the correction is made, which is advantageously a very simple process (a few bit-wise exclusive OR of selected quanta). The target stores the encoded quanta.

The disadvantage of having the client perform the yin yang coding is of course a doubling of the transmission bandwidth required, which is quite unnecessary if the channel is relatively error free. The client may simply send the yang copy of the data. If RAID storage is necessary at the target, the computation of the yin quanta can be readily done at the target. The target then stores both the yin and yang copies striped in 8 disks.

In a retrieval process, a target sends only the yang copy, or both the yang and the yin copies. The client can reconstruct a yang copy upon reception of 4, and in few cases 5, out of 8 quanta.

We can also adopt a PFTA protocol using the yin yang code. The transmitter sends the yang copy of the data. The receiver requests the transmitter to retransmit the yin copy of the data. Thus the receiver can reconstruct the yang copy using a subset of correctly received quanta of the yin and yang copies.

All features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of generic series of equivalent or similar features.

While exemplary embodiments of the invention have been described above, variations, modifications and alterations therein may be made, as will be apparent to those skilled in the art, without departure from the spirit and scope of the invention as set forth in the appended claims.

We claim:

1. A method of transmitting data in a communication system, in which a client device transmits and receives data packets to and from a storage target via a network medium, wherein transmitting data across network layers includes addressing and referencing the data, comprising:
encapsulating the data into data blocks;
transmitting the data blocks through the network medium;
processing the data blocks; and
storing the data blocks on the storage target, wherein the data blocks maintain the same size from encapsulation to storage on the data block, thereby simplifying the addressing and referencing of the data across network layers, and thereby improving the performance of transmitting data in the communication system.

2. The method of claim 1, further comprising the step of networking the data blocks.

3. The method of claim 1, wherein the storing step further comprises storing the data blocks at a memory location at the target and jointly processing multiple layers of a network storage protocol of the data without copying data from one layer to another layer.

4. The method of claim 1, wherein the step of processing the same-sized data blocks includes error control processing.

5. The method of claim 4, wherein the error control processing uses Selective Negative Acknowledgment (SNACK) error processing.

6. The method of claim 1, wherein the step of processing the data blocks includes encrypting the data blocks prior to storing the data blocks on the storage target.

7. The method of claim 6, wherein the step of processing further includes performing a Cyclic Redundancy Code (CRC) check on the data blocks, wherein the CRC check results in verified CRC data.

8. The method of claim 7, wherein the verified CRC data is stored with the data blocks on the storage target.

9. The method of claim 1, wherein the processing step comprises jointly processing more than one protocol layer for errors.

10. The method of claim 1, wherein the processing step comprises encoding, in which a group of data blocks are stored in separate memory disks as a copy of original data of the data blocks, and a negative image copy of the data of the group of data blocks are stored in another set of separate memory disks.

11. The method of claim 10, wherein the negative image copy of each block in a group is an exclusive-OR sum of all blocks in that group other than that block.

12. The method of claim 1, wherein the step of processing the data blocks includes computing an original and negative image Redundant Array of Inexpensive Disks (RAID) code, thereby improving the performance of transmitting data in the communication system.

13. A method of storing data in a network, comprising processing, transmitting, and storing data in a communication system, wherein data is exchanged between at least one client device and at least one data storage target via a network medium using a common fixed size block of data for data blocks across multiple layers of network storage protocol.

14. The method of claim 13, wherein the block of data is a quantum data unit.

15. The method of claim 13, whereby data is stored at a memory location of an end system to be processed by multiple layers of the network storage protocol using a common address and reference, without copying of the block of data from one layer of the protocol to another layer of the protocol.

16. The method of claim 13, wherein the step of processing the fixed-size data blocks includes encrypting data of each block at the at least one client device and storing the data blocks at the target.

17. The method of claim 16, wherein the target does not decrypt the data blocks.

18. The method of claim 17, wherein the processing step further comprises decrypting the data blocks at the at least one client device.

19. The method of claim 13, wherein the processing step includes performing joint error detection for multiple layers of a storage protocol.

20. The method of claim 19, wherein the performing error detection step further comprises detecting errors at an upper layer of a storage protocol by performing computations on the group consisting of prior computations, headers and trailers.

21. The method of claim 13, wherein the step of transmitting comprises error retransmission processing, retransmission processing of same-sized data blocks with detected errors, and combining retransmitted data blocks that resulted from transmission or from higher protocol layers.

22. The method of claim 21, wherein the error transmission processing uses Selective Negative Acknowledgement (SNACK).

23. The method of claim 13, wherein the processing step comprises error correction processing for disk or transmission failure using the fixed-sized data blocks with redundant fixed-sized blocks generated by a clock-wise exclusive-OR of original data blocks, wherein the data blocks and redundant blocks are stored in separate storage disks.

24. The method of claim 23, wherein the redundant blocks are generated by a coding process wherein a first copy comprises more than one fixed-sized blocks of data, and a redundant of each of the more than one same-sized block that is an exclusive-OR sum of all of the more than one blocks other than that block.

25. The method of claim 24, wherein the redundant copy of each block is generated by a mathematical equivalent of an exclusive-OR of that block with a parity of all blocks.

26. The method of claim 25, wherein the parity of all blocks is a block-wise exclusive-OR of all blocks.

27. The method of claim 13, wherein the processing step is performed in one memory location without the copying of data across layers of a network storage protocol.

28. A device implementing storage of data across a network, comprising:
at least one storage device;
a client device in communication with the at least one storage device via a network medium, the client device capable of using network protocol to communicate with the at least one storage device; and
logic cooperating with the client device to process data into common fixed-sized data units and transmit the data units to the at least one storage unit.

29. The device of claim 28, wherein the data units maintain their fixed size across multiple layers of the storage protocol.

30. The device of claim 29, wherein the logic performs a CRC check on the data units and adds a CRC trailer to each data unit after the CRC check verifies the data unit.

31. A data processing system comprising:
a data processing means;
at least one data storage means in communication with the data processing means via a network medium;
means for processing data into common sized data units that maintain the common size across multiple layers of network protocol when the data units are transmitted from the at least one storage device and when the data units are received from the at least one data storage network.

32. The system of claim 31, further comprising means for error control processing.

33. The system of claim 31, further comprising means for verifying data.

34. The system of claim 31, further comprising means for encoding data.

35. The system of claim 31, further comprising means for preparing and storing redundant data on more than one of the storage devices.

36. The system of claim 31, further comprising means for encrypting data.

37. In one of a plurality of computer media, computer code effecting the methods of claim 1.
